(19) United States
(12) Patent Application Publication
(10) Pub. No.: US 2011/0247569 A1
(43) Pub. Date: Oct. 13, 2011

(54) DEVICE FOR EXPELLING MOLES

(76) Inventor: Ulrike Freifrau von Nolcken, Paderborn (DE)

(21) Appl. No.: 13/052,267

(22) Filed: Mar. 21, 2011

(30) Foreign Application Priority Data
Apr. 7, 2010 (DE) 10 2010 003 685.4

(51) Int. Cl. A01K 29/00; F15C 1/00

(52) U.S. Cl. 119/719; 137/560

(57) ABSTRACT

This invention relates to a device for expelling burrowing animals, in particular moles, rodents and such like, which comprises a signal generator unit for producing an expelling signal and a transmission body unit for propagating said expelling signal throughout the soil wherein the transmission body unit includes a number of conduits lines distributed throughout the soil which are of such configuration that the expelling signal will thereby be transmitted and/or distributed in a way ensuring propagation thereof into the soil areas surrounding said lines.

This present invention relates to a device for expelling burrowing animals, in particular moles, rodents and such like, which comprises a signal generator unit for producing an expelling signal and a transmission body unit for propagating said expelling signal throughout the soil.

Prior known from DE 40 21 892 C2 is a device for expelling burrowing animals such as moles which substantially comprises a signal generator unit for producing an expelling signal in the lower audible sound frequency range (70 to 130 Hz). Said signal generator unit is integrated in a bar-shaped casing provided with a screw thread which is adapted to be inserted into the ground. Said bar-shaped casing hence serves as transmission body unit for introducing and/or propagating the expelling signal throughout the soil, though said signal is put in locally in the very spot in which the bar-shaped body is inserted into the ground. Where the expelling signal is to cover up a larger soil area it would be necessary to provide a larger number of scattered bar-shaped bodies. This means an increase of cost because one preferentially battery-powered signal generator unit needs to be provided in each such mounting location. Moreover, maintenance would be relatively extensive as battery changes need to be carried out in several places at the same time.

It is an object of this present invention, therefore, to design a device for expelling burrowing animals in such a way that an efficient and over long time stable expelling of such animals will be ensured with but little maintenance and cost involved.

To achieve this object this present invention is in conjunction with the preamble of claim 1 characterized by the fact that a transmission body unit is provided with a number of conduit lines distributed throughout the soil which are of such configuration that the expelling signal will thereby be transmitted and/or distributed in a way ensuring propagation thereof into the soil areas surrounding said lines.

The invention provides for at least one conduit line to be used for transmission and distribution of an expelling signal produced by a signal generator unit. Advantageously, there is just one signal generator unit needed for at least one conduit run so that the required maintenance extent is substantially reduced. The conduit system transmitting the expelling signal is capable of not just applying and/or radiating the signal precisely to a selected place in the soil, but also in an area mode along a line and/or curve. At least one conduit line appropriately installed can cover up a relatively large area below ground level. Preferably will the strength of the emitted expelling signal be adapted to the length of the line in each case such that at any conduit point distant from the signal generator unit an expelling signal can be given off.

A preferred embodiment of this invention provides for the at least one conduit line of the device to be designed such as to be suitable for transporting and/or distributing a flowing medium such as a liquid for watering. The conduit hence has a dual function as it serves as a means for transmitting and distributing an expelling signal on the one hand and for distributing a flowing medium used for some other purpose on the other hand. This affords the advantage that the extent of installation work may be reduced since the conduit(s) and/or the conduit system will have to be installed under ground just once. According to a preferred embodiment of the invention such multiple use of the conduit is not taking place concurrently, but at different times. In the watering mode of the device the conduit is via a watering control unit connected to a water feed source so that it exclusively serves to receive, distribute and possibly discharge water while in the expelling mode it is in connection with the signal generator unit only to make the preferably air-filled conduit (body) serve as a resonator and/or means for emitting and distributing an expelling signal.

The watering control unit is preferably arranged in such a way in the conduit system that it may be exchanged for the signal generator unit so that the type of service of the conduit may be readily varied in an easy handling mode by simply exchanging these functional components.

A preferred embodiment of this invention provides for a watering conduit system to expel burrowing animals in which one functional unit only of a watering control arrangement is replaced by a signal generator unit. This affords the advantage that a watering device can be simply converted into a device for expelling burrowing animals and vice versa.

One exemplary embodiment of this invention will now be described with reference to the accompanying drawings.

In these drawings:

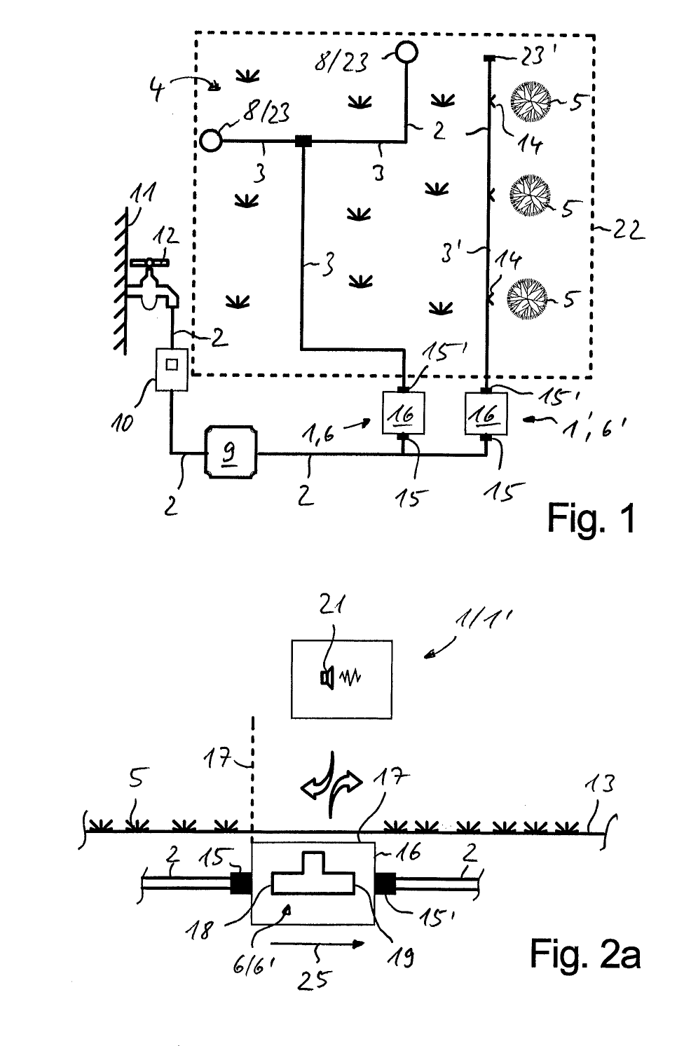

FIG. 1 is a block diagram of a device according to this present invention;

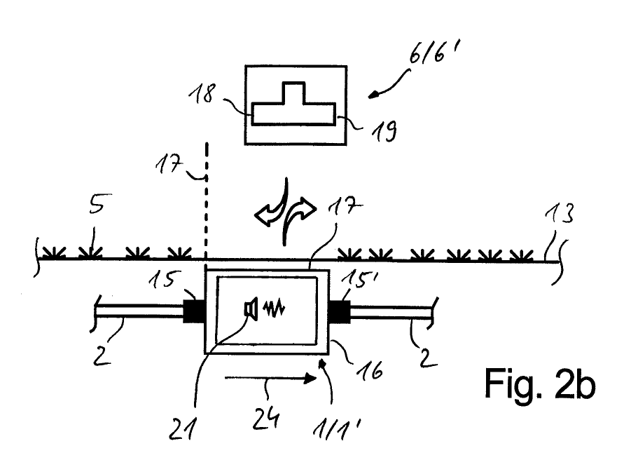

FIG. 2a is a schematic representation of an exchangeable functional unit of a device in the watering mode; and

FIG. 2b is a schematic representation of an exchangeable functional unit of a device in the animal expelling mode.

A device of this present invention may for instance be used to expel burrowing animals such as moles (FIG. 2b). Alternatively it is possible to use said device of this invention wherever a prior-art pipe system for the passage and distribution of flowing media (liquids, gases) or a sewage pipe system is available (FIG. 2b).

The embodiment of a device for expelling burrowing animals according to this invention as per FIGS. 1 and 2b comprises a signal generator unit 1, 1′ for producing an expelling signal which is apt to frighten moles away and a transmission body unit 2 for propagating and/or distributing said expelling signal throughout the soil.

As may be seen from FIG. 1 the transmission body unit 2 is a conduit system comprising a plurality of conduits and/or conduit runs 3, 3′ which are each connected to a signal generator unit 1, 1′. Two such signal generator units 1 and/or 1′ are fitted to go with the two exchangeable different pipe runs 3, 3′ provided for according to this exemplary embodiment.

Conduits 2, 3, 3′ serve a dual function. One of these functions is in an expelling mode shown in FIG. 2b to frighten away and/or expel burrowing animals for which purpose the conduit runs are coupled to the signal generator unit 1, 1′ from which an expelling signal is in sound propagating direction 24 transmitted along said runs 3, 3′.

In the other function the conduits 2, 3, 3′ are in the watering mode as shown in FIG. 2a used for distributing and if necessary for discharging water to irrigate a lawn area 4 and a number of bushes 5.

While in the watering mode a first run 3 of conduits 2 carries water to sprinklers and/or rain guns 7 disposed in different locations via a distribution coupler 7. Said first conduit run 3 is connected to a first watering valve chest 6 which on its part is in communication with a water source (for instance a spigot 12 fitted to a building wall 11) via a conduit 2 preferably with a connector unit 9 and possibly a programming unit 10 also.

The watering valve chest 6, 6′, the connector unit 9 and the programming unit 10 are combined into a watering control unit which enables to adjust the flow rates in each of the conduit runs 3, 3′. According to a not-shown embodiment of the invention it is possible also to omit the connector unit 9 and/or the programming unit 10 such that the watering valve chest 6, 6′ only is constituting the watering control unit.

The programming unit 10 may comprise a microcontroller and a display unit and permit time-controlled water feed via the conduit runs 3, 3′. The connector unit 9 may include a water filter as well as pressure reducing means. While the programming unit 10 may be arranged above the ground level 13 the connector unit 9 and the watering valve chest 6, 6′ serving as watering control unit are fitted below ground level 13.

Conduit 2 and/or the first conduit run 3 as well as the second conduit run 3′ are of hollow profile type. While the first conduit run 3 is a closed-loop system having its ends connected to sprinklers 8 via plug-in couplers while the second conduit run 3′ is in a number of sections provided with a water outlet opening 14 for discharging water drops. These water outlet openings 14 may be integral with the conduit or in the form of separate drop dispensers connected to said conduit 2 by means of coupler elements 15. Water feed in the second conduit run 3′ is accomplished under control by the second watering control unit (watering valve chest 6′) which is connected to the same connector unit 9 as the first watering control unit (watering valve chest 6). The conduit runs 3, 3′ carry water from the respective watering valve chests 6, 6′ in flow direction to the ends 23, 23′.

The mentioned functional units such as watering valve chests 6, 6′, sprinklers 8, connector unit 9, programming unit 10 are preferably connected to their conduit lines 2 by means of plug-in type coupler elements 15. Conduits 2 may consist of pipes or flexible tubes which substantially extend below ground level 13 wherever required.

This present exemplary embodiment provides for the water valve chest 6, 6′ to be easily replaceable by a signal generator unit 1, 1′. Both components are dimensioned such that they can be installed into an underground casing 16 with hinged cover 17 and connected to the conduit run 2. The open state of said cover 17 is shown in dashline representation in FIGS. 2a and 2b. The watering valve chest 6, 6′ has an inlet connecting piece 18 and an outlet connecting piece 19 each adapted to be joined with conduit run 3 via coupler elements 15.

The signal generator unit 1, 1′ has a casing with a connector which serves to accommodate an element for excitation by sound vibration (electromechanical sound generator element 21). Said electromechanical sound generator element can be induced to produce sound vibrations by an electric motor or a piezoelectric element. It is coupled and/or connected to its associated conduit run 3, 3′ in such a way that sound vibrations will be distributed along conduit run 3, 3′ and further introduced into the soil. The electromechanical sound generator element 21 disposed inside the signal generator unit 1, 1′ may be supplied with energy as needed for operation by a power supply unit and/or power pack. The Conduits 2 and their runs 3, 3′ are constituting sort of a resonance body while in the expelling mode which body propagates and/or conveys the expelling signal thus generated to a lawn area 4 and a bed area 5. This signal disturbs the burrowing animals and expels them.

When in the summertime the conduit system 2 is used for garden watering (watering mode) with the watering valve chests 6, 6′ installed inside the respective underground casings 16 it is possible to avail of idling periods outside programmed watering periods for changing the device over to the animal expelling mode by replacing each of the watering valve chests 6 6′ by a signal generator unit 1, 1′. For that purpose, the cover 17 disposed in a recess of the lawn area 5 at ground surface level with the ground surface 13 will be swung up into an open position to provide access to the watering valve chest 6, 6′. On detaching said chest 6, 6′ from its coupler element 15, 15′ same may be removed and replaced by a signal generator unit 1, 1′ having one end connected to the coupler element 15′ of the conduit run. The signal generator unit 1, 1′ may comprise a microprocessor operated control unit by means of which such conditions as intensity, sound frequency and on-time and/or intermittent operation mode may be set.

As may be seen from FIG. 1 the underground conduit system 2 distributed over the estate may be used on the one hand for watering plants and on the other hand for expelling moles.

Another not-shown embodiment of the invention provides for the signal generator units 1, 1′ to be arranged in a separate keep-space underground casing which would have to be disposed close to a watering valve chest 6, 6′, namely between the ends 23 and/or 23′ of the conduit runs 3 and/or 3′ and the underground casing 16. With the device in the animal expelling mode the signal generator units 1, 1′ would be in place and active while direct coupled to the conduit runs 3, 3′. With the system in the watering mode, however, the signal generator units 1, 1′ would be removed from the keep-space casing and replaced by a connecting pipe or tube which would be connected to the opposite openings of the keep-space casing such that water may flow towards the conduits runs 3, 3′ for watering.

According to an alternative embodiment of this invention it is possible to have the conduit runs 3, 3′ connected to just one (common) of the watering valve chests 6, 6′ instead of two while in the watering mode and to just one common signal generator unit while in the animal expelling mode.

Another not-shown alternative embodiment permits the signal generator units 1, 1′ and the watering control unit with its functional units 6, 6′, 9, 10 to operate also concurrently. The signal generator units 6, 6′ could for instance be integrated in one common casing or in several casings so that continuous operation both in the animal expelling and in the watering mode will be ensured.

1. A device for expelling burrowing animals, in particular moles, rodents and such like, which comprises a signal generator unit for producing an expelling signal and a transmission body unit for propagating said expelling signal within the soil, wherein the transmission body unit includes a number of conduits (2, 3, 3′) which are distributed throughout the soil and designed in such a way that the expelling signal is transmitted and/or distributed by means of said conduits 2. 3, 3′ and propagated in the soil (13) surrounding the conduits (2, 3, 3′) in an area mode.

2. The device according to claim 1, wherein the conduits (2, 3, 3′) are of such design that they are additionally adapted to distribute a flowing medium.

3. The device according to claim 1, wherein the conduits (2, 3, 3′) are hollow-profiled, have water outlet openings (14) in defined positions and can be connected to one another by means of coupler elements (15, 15′) to provide a branched conduit system (2, 3, 3′) to distribute a water as the flowing medium for irrigating plants in the soil.

4. The device according to claim 1, wherein at least one conduit (2, 3, 3′) is in the burrowing animals expelling mode, on the one hand, connected to the signal generator unit (1, 1′) and in the watering mode, on the other hand, in communication with a watering control unit (6, 6′) controlling the water feed.

5. The device according to claim 1, wherein on the one hand the conduit (2, 3, 3′) is in the animal expelling mode connected only to the signal generator unit (1, 1′) and in the watering mode only to the watering control unit (6, 6′) or that on the other hand the conduit (2, 3, 3′) is in communication with both the signal generator unit (1, 1′) and the watering control unit (6, 6′) to operate concurrently in the animal plus the watering mode.

6. The device according to claim 1, wherein the signal generator unit (1, 1′) and the watering control unit (6, 6′) are each connectable to conduit (2, 3, 3′) by means of a coupler element (15, 15′).

7. The device according to claim 1, wherein the watering control unit comprises a watering valve chest (6, 6′) which can be coupled with a water source (12) either direct or via a connector unit (9) and/or a programming unit (10).

8. The device according to claim 1, wherein the signal generator unit (1, 1′) has a casing in which an electromechanical sound generator element (21) is installed.

9. A method for expelling burrowing animals, in particular moles, rodents and such like, which comprises
providing a signal generator unit for producing an expelling signal and a transmission body unit for propagating said expelling signal within the soil, wherein the transmission body unit includes a number of conduits (2, 3, 3′) which are distributed throughout the soil and designed in such a way that the expelling signal is transmitted and/or distributed by means of said conduits 2. 3, 3′ and propagated in the soil (13) surrounding the conduits (2, 3, 3′ in an area mode, and
driving said signal generator unit to produce said expelling signal.

10. A watering line arrangement for expelling burrowing animals wherein a functional unit (6, 6′) connected to a conduit (2, 3, 3′) is replaced by a signal generator unit (1, 1′) that feeds an expelling signal in the sound wave range into the at least one conduit (2, 3, 3′).

11. The method as in claim 9, wherein said conduits are pipes.

12. The method as in claim 9, wherein said conduits form a sewer system.
